(19) United States
(12) Patent Application Publication
(10) Pub. No.: US 2023/0008249 A1
(43) Pub. Date: Jan. 12, 2023

(54) LID ASSEMBLY FOR A CONTAINER

(71) Applicant: Rehrig Pacific Company, Los Angeles, CA (US)

(72) Inventors: Derick Foster, Cumming, GA (US); John Matthew Thomson, Dahlonega, GA (US); Derek Gravitt, Buford, GA (US)

(21) Appl. No.: 17/857,490

(22) Filed: Jul. 5, 2022

Related U.S. Application Data
(60) Provisional application No. 63/219,141, filed on Jul. 7, 2021.

(51) Int. Cl. B65F 1/16; B65F 1/02

(52) U.S. Cl. CPC B65F 1/1615; B65F 1/02; B65F 1/1646

(57) ABSTRACT

A lid assembly for a cart includes an outer wall defining an outer surface of a lid. An inner wall defines an inner surface of the lid. A hasp is pivotably connected to the lid and is moveable between an extended position and a retracted position. A plurality of flexible arms extend from the lid towards the hasp.

### CROSS-REFERENCE TO RELATED APPLICATIONS

This application claims priority to U.S. Provisional Application No. 63/219,141 which was filed on Jul. 7, 2021 and is incorporated herein by reference.

### BACKGROUND

The present disclosure relates to containers and, more particularly, to retaining waste within the container.

Containers, such as roll-out carts, are commonly used by municipalities for collecting garbage from households or businesses. The containers are movable by tipping and balancing the container on a pair of wheels adjacent a rear side of the base of the container. It is common for these containers to contain food waste that may attract animals in the area that would open the container and spread the waste. A lid on the container can prevent many animals from accessing the food waste. However, in the case of larger animals, such as with bears, additional steps, such as the use of a lock, may need to be taken to prevent the bear from accessing the contents in the container.

### SUMMARY

In one exemplary embodiment, a lid assembly for a cart includes an outer wall defining an outer surface of a lid. An inner wall defines an inner surface of the lid. A hasp is pivotably connected to the lid and is moveable between an extended position and a retracted position. A plurality of flexible arms extend from the lid towards the hasp.

In another embodiment according to any of the previous embodiments, the plurality of flexible arms includes a first set of flexible arms located on a first lateral side of the hasp. A second set of flexible arms is located on a second lateral side of the hasp.

In another embodiment according to any of the previous embodiments, the first set of flexible arms extend from a first mounting bracket. The second set of flexible arms extend from a second mounting bracket.

In another embodiment according to any of the previous embodiments, the plurality of flexible arms include a proximal portion that has a first stiffness and a distal portion that has a second stiffness that is less than the first stiffness.

In another embodiment according to any of the previous embodiments, the proximal portion includes a polymeric material. The distal portion includes a rubber material.

In another embodiment according to any of the previous embodiments, the inner wall defines a trough adjacent a perimeter for accepting an upper edge of a cart.

In another embodiment according to any of the previous embodiments, the trough is defined by an outer lip and an inner ridge.

In another embodiment according to any of the previous embodiments, the inner ridge includes a recessed area including the hasp.

In another embodiment according to any of the previous embodiments, at least a portion of the plurality of flexible arms extend into the recessed area.

In another embodiment according to any of the previous embodiments, the outer lip includes a double walled thickness defined by the inner wall and the outer wall.

In another embodiment according to any of the previous embodiments, the plurality of flexible arms include an inner column of vertically arranged flexible arms and an outer column of vertically arranged arms. The inner column being vertically offset from the outer column.

In another exemplary embodiment, a cart includes a body portion defining a receptacle. A lid is pivotably connected to the receptacle. The lid includes an outer wall defining an outer surface of the lid. An inner wall defines an inner surface of the lid. A hasp is pivotably connected to the lid and moveable between an extended position and a retracted position. A plurality of flexible arms extend from the lid towards the hasp. A lock for selectively engaging the hasp is in the extended position.

In another embodiment according to any of the previous embodiments, the plurality of flexible arms includes a first set of flexible arms located on a first lateral side of the hasp. A second set of flexible arms is located on a second lateral side of the hasp.

In another embodiment according to any of the previous embodiments, the first set of flexible arms extend from a first mounting bracket. The second set of flexible arms extend from a second mounting bracket.

In another embodiment according to any of the previous embodiments, the plurality of flexible arms include a proximal portion that has a first stiffness. A distal portion has a second stiffness that is less than the first stiffness.

In another embodiment according to any of the previous embodiments, the inner wall defines a trough adjacent a perimeter of the lid for accepting an upper edge of a cart. The trough is defined by an outer lip and an inner ridge.

In another embodiment according to any of the previous embodiments, the inner ridge includes recessed area including the hasp. At least a portion of the plurality of flexible arms extend into the recessed area.

In another embodiment according to any of the previous embodiments, a method of operating a hasp on a lid assembly of a cart. A hasp attached to a lid is pivoted from one of a retracted position or an extended position through a plurality of flexible arms to the other of the retracted position or the extended position. The hasp on the lid assembly is engaged with a lock fixed to a body portion when the hasp is in the extended position and the lid is in a closed position.

In another embodiment according to any of the previous embodiments, the lid assembly includes a trough defined in an inner wall of the lid that has a recessed area with the hasp located in the recessed area.

In another embodiment according to any of the previous embodiments, at least a portion of the plurality of flexible arms extend into the recessed area.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an example roll-out cart.

FIG. 2 illustrates a perspective view of an underside of a lid on the cart of FIG. 1.

FIG. 3 illustrates a first and second set of flexible arms.

FIG. 4 illustrates an enlarged view of the first and second set of flexible arms from FIG. 2 with a hasp in an unlocked position.

FIG. 5 illustrates an enlarged view of the first and second flexible arms from FIG. 2 with a hasp in a locked position.

FIG. 6 illustrates a cross-sectional view through a center of the cart of FIG. 1.

FIG. 7 illustrates the lid on the cart of FIG. 1 in a partially opened position.

FIG. 8 illustrates a rear perspective view of the lid.

FIG. 9 illustrates another example first and second set of flexible arms on the lid of the cart of FIG. 1.

### DETAILED DESCRIPTION

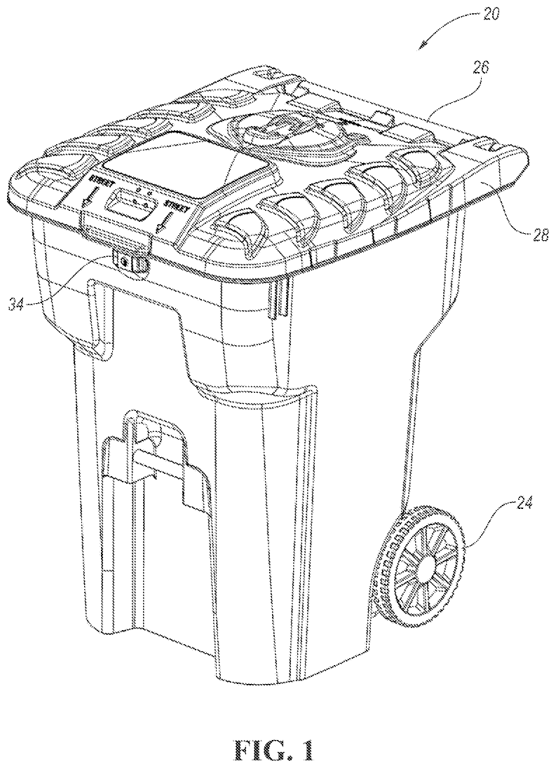

FIG. 1 illustrates an example cart 20, such as a roll-out cart, having a body portion 22 defining a receptacle for storing debris, such as food waste, and a lid 28 for selectively enclosing the body portion 22. Wheels 24 are located adjacent a rear of the base of the cart 20 to allow the cart 20 to be tipped and balanced for moving the cart 20 along a surface, such as a road or driveway. A handle 26 is located along a pivoting axis of the lid 28 to facilitate pivoting the cart 20 onto the wheels 24.

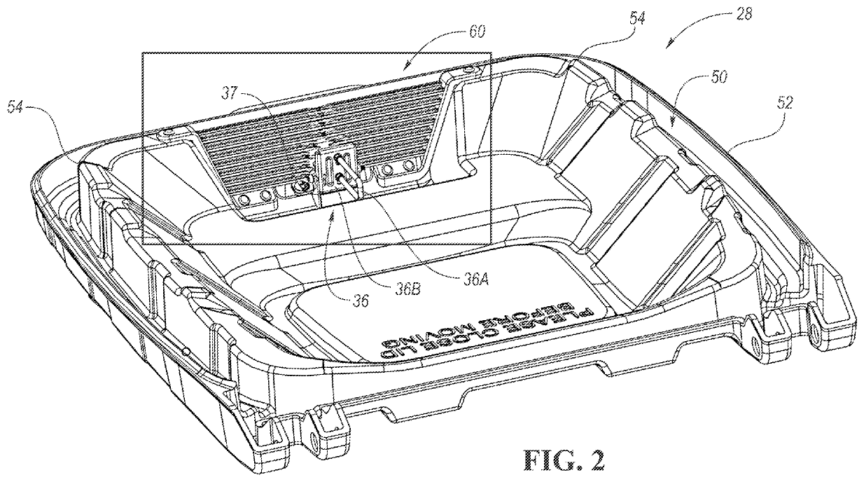

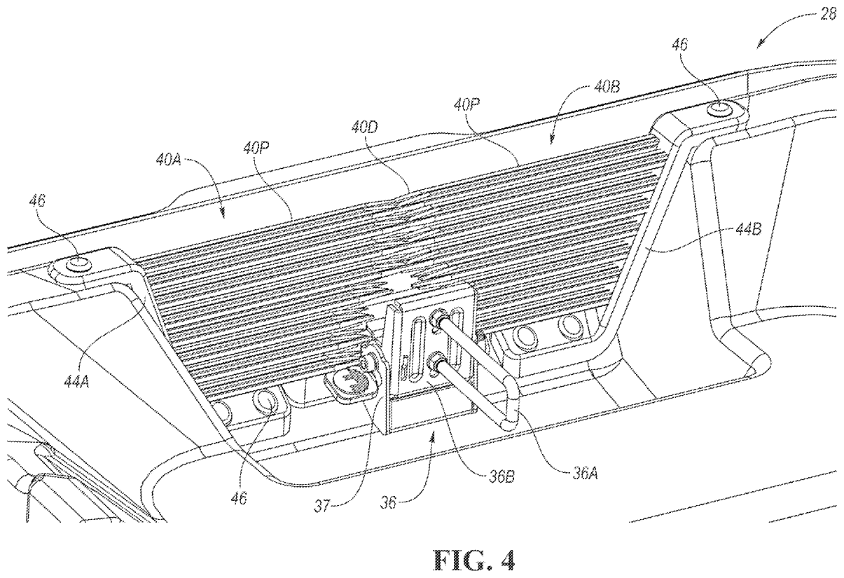

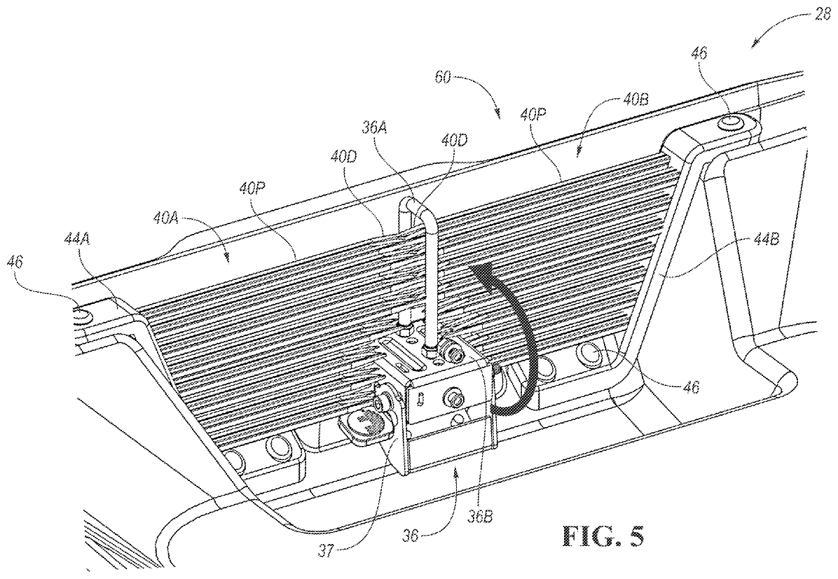

The cart 20 includes a lock 34 fixed relative to the body portion 22 and located on opposite side of the cart 20 from the handle 26. The lock 34 is used to selectively fix the lid 28 relative to the body portion 22 to prevent access into the cart 20 by animals, such as raccoons or bears when the lid 28 is closed. To selectively secure the lid 28 relative to the body portion 22, the lock 34 engages a hasp 36, as shown in FIG. 2, when the hasp 36 is in an extended position. The hasp 36 includes an elongated profile with a length greater than its width. The hasp 36 is also pivotably attached to the lid 28 for movement between a retracted position, as shown in FIG. 4, and the extended position, as shown in FIG. 5. The lock can only engage the hasp 36 in the extended position when the lid 28 is closed. Accordingly, when the hasp 36 is in the retracted position, the lock 34 cannot secure the lid 28 relative to the body portion 22 such that the lid 28 would open and close similar to a traditional lid.

The hasp 36 forms a U-shaped projection 36A extending from a base plate 36B with the base plate 36B being pivotably attached to a mounting plate 37 on the lid 28 along one edge of the base plate 36B. When the hasp 36 is in the retracted position, it is unable to engage the lock 34, which disables the locking function of the lid 28. However, when the hasp 36 is in the extended position, the hasp 36 is able to engage the lock 34 to allow selective access into the cart 20.

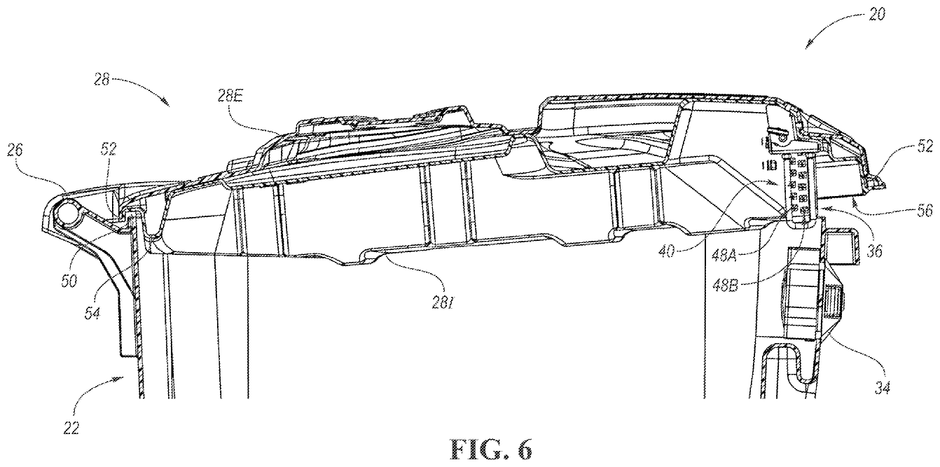

As shown in FIGS. 2 and 6, the lid 28 includes a trough 50 extending around a perimeter of the lid 28 for accepting an upper edge of the body portion 22. The trough 50 is defined by an outer lip 52 that extends downward past the upper edge along an exterior side of the body portion 22 and an inner ridge 54 that extends downward past the upper edge of an interior side of the body portion 22. In the illustrated example, the outer lip 52 includes a double wall thickness formed by an exterior layer 28E of the lid 28 and an interior layer 281 of the lid 28 that contact each other. In particular, an outer surface of the interior layer 281 engages select portions of an interior surface of the exterior layer 28E. The inner ridge 54 that partially defines the trough 50 is formed from changes in the contour of the interior layer 281 of the lid 28.

In the illustrated example, the inner ridge 54 extends downward past the upper edge of the body portion 22 by an amount greater than the outer lip 52 extends downward past the upper edge along an exterior of the body portion 22. One feature of this configuration is an improved ability to prevent debris from leaving the cart 20 if the lid 28 becomes deformed or if the cart 20 tips over onto a floor or ground surface. In particular, the inner ridge 54 forms an area of overlap with the body portion 22 in addition to the outer lip 52 to create a tortuous path that reduces the loss of debris from inside the cart 20.

The inner ridge 54 also provides improved rigidity to the lid 28 to resist damage and/or deformation from bear contact. In the illustrated example, the inner ridge 54 is formed from a single one of the interior layers 281. The interior layer 281 is fixed to a single one of the exterior layers 28E at multiple locations to provide the lid 28 with a double-wall configuration that improves the strength over traditional single walled lid designs. In this disclosure, directions, such as upper or lower, are in relation to a normal position of the cart 20 as shown in FIG. 1 with the rear of the cart 20 being adjacent the handle 26 and a front of the cart 20 being opposite the handle 26 unless stated otherwise.

As shown in FIGS. 2 and 4-6, the hasp 36 is located in a recessed portion 60 along a front side of the lid 28. The recessed portion 60 is defined by the inner ridge 54 and the hasp 36 and is secured relative to at least one of the interior layer 281 or the exterior layer 28E of the lid 28. The hasp 36 includes the U-shaped projection 36A attached at opposing ends of the U to the base plate 36B. The base plate 36B is pivotably connected to the mounting plate 37 with the mounting plate 37 being rigidly secured to an underside of the lid 28. The connection between the hasp 36 and the mounting plate 37 allows the hasp 36 to pivot between an extended position (FIG. 5) located within the recessed portion 60 and a retracted position (FIG. 4) at least partially spaced from the recessed portion 60 and extending towards a central region of the lid 28.

The lid 28 includes multiple flexible arms 40 that extend across the recessed portion 60 to at least partially enclose the recessed portion 60 in the inner ridge 54. When the hasp 36 is in the extended position, the hasp 36 is surrounded by the flexible arms 40. In the illustrated example, the flexible arms 40 may extend into an opening formed by the U-shaped projection 36A and the base plate 36B when the hasp 36 is in the extended position.

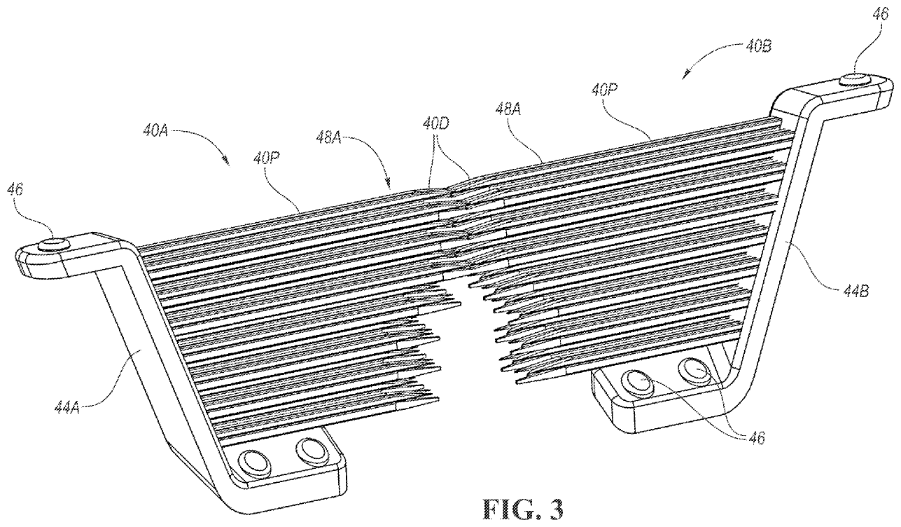

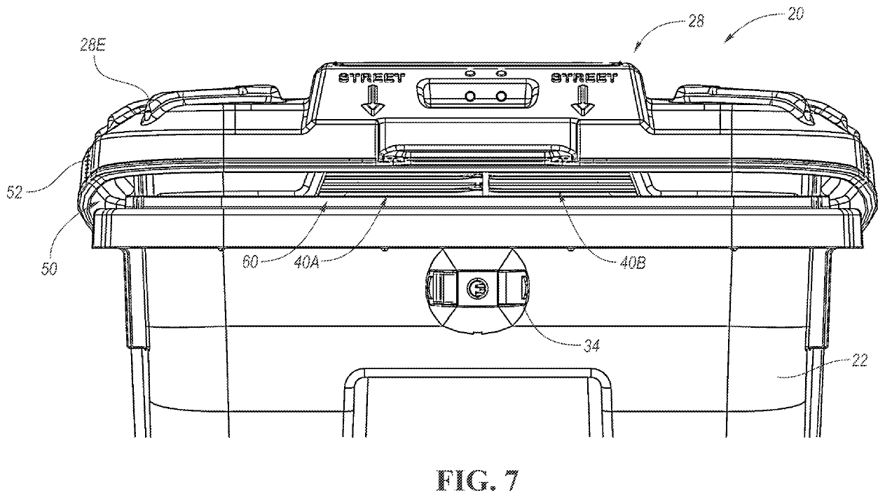

As shown in FIGS. 2-7, the flexible arms 40 extend laterally or horizontally across the recessed portion 60 in the lid 28. The flexible arms 40 include a first set of arms 40A and a second set of flexible arms 40B that are fixed relative to a first mounting bracket 44A and a second mounting bracket 44B, respectively, on a first end of the flexible arms 40 and free or unrestricted on a second or distal end of the flexible arms 40. The mounting brackets 44A, 44B are separately attached to the lid 28 through the use of fasteners 46 that engage the lid 28. Also, in the illustrated example, the flexible arms 40 include an inner column of arms 48A vertically arranged adjacent an interior side of the cart 20 and an outer column of arms 48B vertically arranged adjacent the exterior side of the cart 20. Also, as shown in FIG. 6, the inner and outer columns of arms 48A, 48B are at least partially vertically offset to prevent material passing through the openings between adjacent flexible arms 40.

In the illustrated example, the flexible arms 40 comprise a proximal portion 40P adjacent the mounting bracket 44A having a first stiffness and a distal portion 40D having a second stiffness that is less than the first stiffness. In one example, the proximal portion 40P extends at least 50% of a length of the flexible arms 40 and in another example, the proximal portion extends at least 80% of the length of the flexible arms 40. The distal portion 40D also includes laterally offset fingers that improve the ability of the distal portion 40D to deflect.

One feature of varying the stiffness between the proximal and distal portions is to allow the hasp 36 to pivot through the distal portions 40D of the flexible arms 40 with less resistance while the proximal portions 40P remain largely undeflected. The proximal portion 40P of the flexible arms 40 can be made of a polymeric material and the distal portion 40D of the flexible arms 40 can be made of a different polymeric material or a rubber material. Alternatively, each of the flexible arms 40 could be made of a single unitary piece of material, such as a polymeric material.

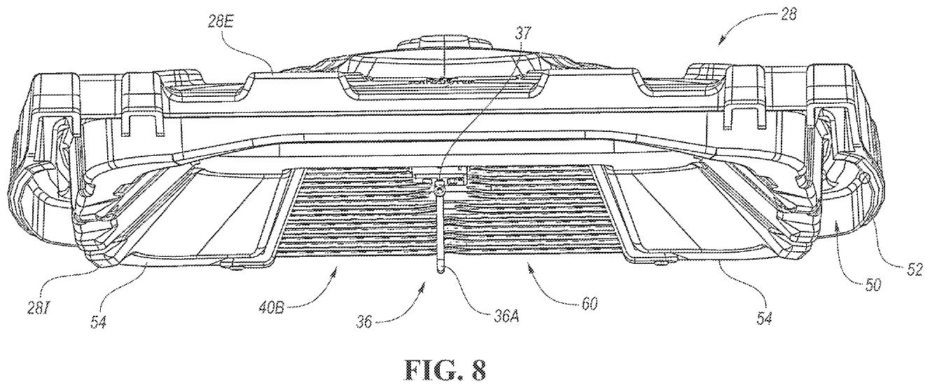

The flexible arms 40 include varying lengths that follow the wider profile of the base plate 36B to allow it to pivot through the flexible arms 40 and the narrower profile of the U-shaped projection 36A to prevent debris from inside the cart 20 from passing between the hasp 36 and the flexible arms 40 as shown in FIGS. 5 and 8.

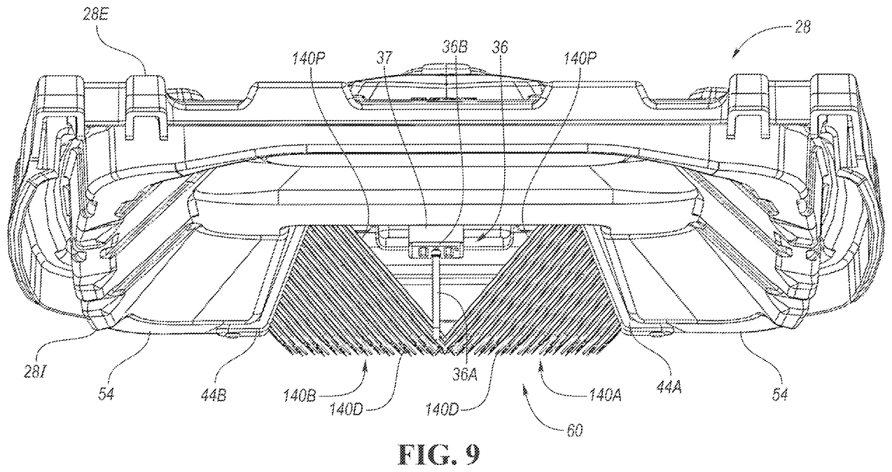

FIG. 9 illustrates another set of flexible arms 140, similar to the flexible arms 40 described above except where shown in the Figures. The flexible arms 140 include a first set of arms 140A that extend from the mounting bracket 44A and a second set of arms 140B that extend from the mounting bracket 44B. The first and second set of arms 140A, 140B extend in a direction having a component in a horizontal direction towards the hasp 36 and a vertical direction towards the body portion 22 or away from the lid 28. This creates proximal portions 140P with varying lengths between adjacent flexible arms 140 while distal portions 140D remain a constant length. Furthermore, the first and second set of arms 140A, 140B can extend vertically from the mounting brackets 44A, 44B away from the lid 28 and towards the body portion 22.

Although the different non-limiting examples are illustrated as having specific components, the examples of this disclosure are not limited to those particular combinations. It is possible to use some of the components or features from any of the non-limiting examples in combination with features or components from any of the other non-limiting examples.

It should be understood that like reference numerals identify corresponding or similar elements throughout the several drawings. It should also be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claim should be studied to determine the true scope and content of this disclosure.

What is claimed is:

1. A lid assembly for a cart comprising:
an outer wall defining an outer surface of a lid;
an inner wall defining an inner surface of the lid;
a hasp pivotably connected to the lid and moveable between an extended position and a retracted position; and
a plurality of flexible arms extending from the lid towards the hasp.

2. The lid assembly of claim 1, wherein the plurality of flexible arms includes a first set of flexible arms located on a first lateral side of the hasp and a second set of flexible arms located on a second lateral side of the hasp.

3. The lid assembly of claim 2, wherein the first set of flexible arms extend from a first mounting bracket and the second set of flexible arms extend from a second mounting bracket.

4. The lid assembly of claim 2, wherein the plurality of flexible arms include a proximal portion having a first stiffness and a distal portion having a second stiffness that is less than the first stiffness.

5. The lid assembly of claim 4, wherein the proximal portion includes a polymeric material and the distal portion includes a rubber material.

6. The lid assembly of claim 1, wherein the inner wall defines a trough adjacent a perimeter for accepting an upper edge of a cart.

7. The lid assembly of claim 6, wherein the trough is defined by an outer lip and an inner ridge.

8. The lid assembly of claim 7, wherein the inner ridge includes recessed area including the hasp.

9. The lid assembly of claim 8, wherein at least a portion of the plurality of flexible arms extend into the recessed area.

10. The lid assembly of claim 7, wherein the outer lip includes a double walled thickness defined by the inner wall and the outer wall.

11. The lid assembly of claim 1, wherein the plurality of flexible arms include an inner column of vertically arranged flexible arms and an outer column of vertically arranged arms with the inner column being vertically offset from the outer column.

12. A cart comprising:
a body portion defining a receptacle; and
a lid pivotably connected to the receptacle, the lid including:
an outer wall defining an outer surface of the lid;
an inner wall defining an inner surface of the lid;
a hasp pivotably connected to the lid and moveable between an extended position and a retracted position;
a plurality of flexible arms extending from the lid towards the hasp; and
a lock for selectively engaging the hasp in the extended position.

13. The cart of claim 12, wherein the plurality of flexible arms includes a first set of flexible arms located on a first lateral side of the hasp and a second set of flexible arms located on a second lateral side of the hasp.

14. The cart of claim 13, wherein the first set of flexible arms extend from a first mounting bracket and the second set of flexible arms extend from a second mounting bracket.

15. The cart of claim 13, wherein the plurality of flexible arms include a proximal portion having a first stiffness and a distal portion having a second stiffness that is less than the first stiffness.

16. The cart of claim 12, wherein the inner wall defines a trough adjacent a perimeter of the lid for accepting an upper edge of a cart and the trough is defined by an outer lip and an inner ridge.

17. The cart of claim 16, wherein the inner ridge includes recessed area including the hasp and at least a portion of the plurality of flexible arms extend into the recessed area.

18. A method of operating a hasp on a lid assembly of a cart:
pivoting a hasp attached to a lid from one of a retracted position or an extended position through a plurality of flexible arms to the other of the retracted position or the extended position; and
engaging the hasp on the lid assembly with a lock fixed to a body portion when the hasp is in the extended position and the lid is in a closed position.

19. The method of claim 18, wherein the lid assembly includes a trough defined in an inner wall of the lid having a recessed area with the hasp located in the recessed area.

20. The method of claim 19, wherein at least a portion of the plurality of flexible arms extend into the recessed area.
